(19) United States
(12) Patent Application Publication
(10) Pub. No.: US 2015/0348092 A1
(43) Pub. Date: Dec. 3, 2015

(54) Game and Competition Based Method of Advertising

(71) Applicant: Thomas V. Chimento, Peachtree City, GA (US)

(72) Inventor: Thomas V. Chimento, Peachtree City, GA (US)

(21) Appl. No.: 14/727,662

(22) Filed: Jun. 1, 2015

Related U.S. Application Data
(60) Provisional application No. 62/005,217, filed on May 30, 2014.

(51) Int. Cl. G06Q 30/02; G06F 3/0481; G07F 17/32

(52) U.S. Cl. CPC G06Q 30/0245; G07F 17/3255; G07F 17/3211; G07F 17/3269; G06F 3/04817

(57) ABSTRACT

A method for online advertisement which utilizes an interactive game as incentive to view advertisements. The method includes providing a user with a plurality of advertisements, each including specific graphic content. The use may pick and view any of the advertisements through a grid of selectable icons, wherein each icon is associated with a specific advertisement. The goal of the game is the identification of a set of correct advertisements that are included within the plurality of advertisements. The method enables the user to do so through an identifier and a hint. An identifier is included in the graphic content for each of the correct advertisements. The hint provides the user with information relating to the identifier and is displayed to the user with a series of checkboxes. The user is then prompted to enter a guess entry for each checkbox in order to guess the set of correct advertisements.

The current application claims a priority to the U.S. Provisional Patent application Ser. No. 62/005,217 filed on May 30, 2014. The current application is filed on Jun. 1, 2015 while May 30, 2015 was on a weekend.

### FIELD OF THE INVENTION

The present invention relates generally to online advertising which has become increasingly common as use of the Internet has become widespread. More specifically, the present invention is a game and competition based method of advertising. The present invention challenges users to find a set of certain objects which are hidden throughout various different advertisements of varying media type, such as videos and images.

### BACKGROUND OF THE INVENTION

There are many different types of advertising which exist in the modern world. Perhaps the most common forms of advertising include the following techniques; outdoor advertising, broadcast advertising, and Internet advertising. Outdoor advertising is one of the oldest and most widespread forms of advertising in the world. Outdoor advertising comprises virtually any form of sign, poster, flyer, sticker, or otherwise which is utilized for the purposes of spreading information about some product or service. Some of the most common forms of outdoor advertising include billboards and posters. Although this method of advertising is quite basic, it has been updated by technology in recent years. For example, modern billboards often comprise a digital light emitting diode (LED) display which produces an image that may be altered at a moment's notice. This allows for semi-dynamic advertisements, or possibly even video advertisements to be carried out using the outdoor advertising technique. Broadcast and Internet advertising are two very similar methods of advertising in which advertisements are strategically placed in media or on websites which potential consumers visit routinely. Broadcast advertising focuses on distribution of advertisements via radio and television whereas Internet advertising relies upon the global computing information exchange network known as the Internet.

Advertisements have been constantly growing in their complexity and efficiency with companies always developing new ways to motivate consumers to buy products or services. In order to drive continual development of advertisements, companies will often gather as much data as possible about any given advertisement released to the public. Companies typically gather metrics such as demographics of viewers of the advertisement, the number of clicks an online advertisement receives and, if possible, the number of times interaction with the advertisement results in the sale of their product. Such information helps show a company which advertisements are the most successful, and can offer insight necessary to improve advertisements which are less successful. Online advertisements are very effective at providing companies with several useful metrics such as the number of times the advertisement is clicked on, and sometimes whether or not interaction with the advertisement lead to a purchase of the company's product. However, one particular metric that is commonly lacking in such analyses is the amount of time a user has spent looking at a given advertisement. This metric is typically not present as it is difficult to measure with current advertising methodologies. Many companies would greatly like to know how long a given user observes their advertisement in addition to other typically gathered metrics. Such information would be invaluable to a company which is interested in improving advertisement designs in order to become more effective at selling the company's product.

It is therefore an objective of the present invention to create a game and competition based method of advertising which allows a company to gather excellent metrics with regards to the effectiveness of their advertisements. It is a further objective of the present invention to utilize prizes and other rewards as an incentive for playing the game outlined by the present invention.

The present invention is essentially a media scavenger hunt, the user searches through advertisement content for clues and hints. During play of the game, the user must view a multitude of different advertisements and attempt to find objects which are hidden within those advertisements. When a user thinks they have found one of the hidden objects, they can add the advertisement to a scorecard in the proper position. The user is challenged to find a specific set of objects within advertisements and to do so within a set period of time. The advantage of the present invention is that it allows companies to gather information on how many times their advertisement is clicked or viewed as well as how long their advertisement is viewed by any given user. The prizes that may be won by the user offer the necessary incentive to attract a large group of users which enables companies to gather useful information about their advertisements. Thus, the present invention offers significant advantage for companies who wish to determine the effectiveness of their advertisements.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a flow diagram depicting the overall process of the present invention.

FIG. 2 is a flow diagram depicting the steps required for executing a time limit for the present invention.

FIG. 3 is a flow diagram depicting the association of overall process with a user profile.

FIG. 4 is a flow diagram depicting the gathering of a plurality of behavioral metrics.

FIG. 5 is a flow diagram depicting the steps required to identify contestants from the plurality of contestants associated with a verified set of selected advertisements.

FIG. 6 is a flow diagram depicting the steps required to identify a winning contestant.

FIG. 7 is a visual example depicting illustrating the graphic components of the present invention on a display screen, wherein the graphic components include the grid of selectable icons and the series of checkboxes.

FIG. 8 is a diagram illustrating the graphic components of the present invention on a display screen.

### DETAIL DESCRIPTIONS OF THE INVENTION

All illustrations of the drawings are for the purpose of describing selected versions of the present invention and are not intended to limit the scope of the present invention.

The present invention is a method for advertisement on the Internet. More specifically, the present invention is an online advertisement method which provides advertisement content to the user through an interactive game. The present invention further promotes the viewing of advertisement content by integrating a competitive aspect into the interactive game, allowing a multitude of users to compete against each other to earn awards and prizes. Throughout the various processes of the interactive game, the present invention also tracks and gathers various descriptive metrics on each user in order to identify effective and ineffective advertisement content. Thus, the present invention provides a new means for online advertisement that not only grants excellent product exposure for companies, but also allows them to gather useful metrics that may be used to further improve their advertisements.

The method of the present invention is a software application executed by a computing device. The present invention is preferably integrated into a website that is hosted on at least one server and is accessible through the Internet. The server provides significant amounts of data storage to be used by the present invention for the storage of user information, advertisement content, and other pertinent content/information. The user may access the website, and therefore the present invention, through a user device. The user device may be virtually any modern computing device which possesses an Internet connection and a user interface; the user device allows the user to access the present invention in order to take part in the interactive game, view advertisements, and interact with other features of the present invention. Types of user devices include, but is not limited to, desktop computers, laptop computers, smart phones, and tablet computers. Thus, the present invention may be easily accessible by users who have a wide range of different computing devices.

In general, the present invention is a media scavenger hunt integrated into a website. The present invention provides the user with a plurality of advertisements, wherein each of the plurality of advertisements includes graphic content (Step A). Graphic content may be in the form of an image or a video that promotes the consumptions of goods, services, or any other types of commodity; in one embodiment, the graphic content may also include audio content. The present invention allows the user to select and view any of the advertisements from the plurality of advertisements and play an interactive game at the simultaneously which has real world prizes and awards. The goal of the game is for the user to find and identify a set of correct advertisements that is included amongst the plurality of advertisements. The present invention enables the user to do so by providing him or her with an identifier that is hidden in the graphic content of each of the correct advertisements (Step B). Various types of identifiers may be used for the present invention with an associated difficulty level. Any type of information from the graphic content, each with an associated theme, difficulty, or message. Various type of identifiers includes, but is not limited to, audio recordings, images, color schemes, objects, word, and political/movie/ideology references. For example, one of the identifiers is a soccer ball, and the associated correct advertisement is a commercial for the world cup which features said soccer ball throughout the commercial. The preferred type of identifier is a graphic-based identifier, such as an image or an object. The user simply chooses and watches advertisements from the plurality of advertisements in order to identify the correct advertisements based on the presence of the identifiers within the associated graphic content. In the process, the present invention facilitates excellent product exposure for companies, goods, services, commodities, and other information portrayed by or included in the graphic content of each of the advertisements.

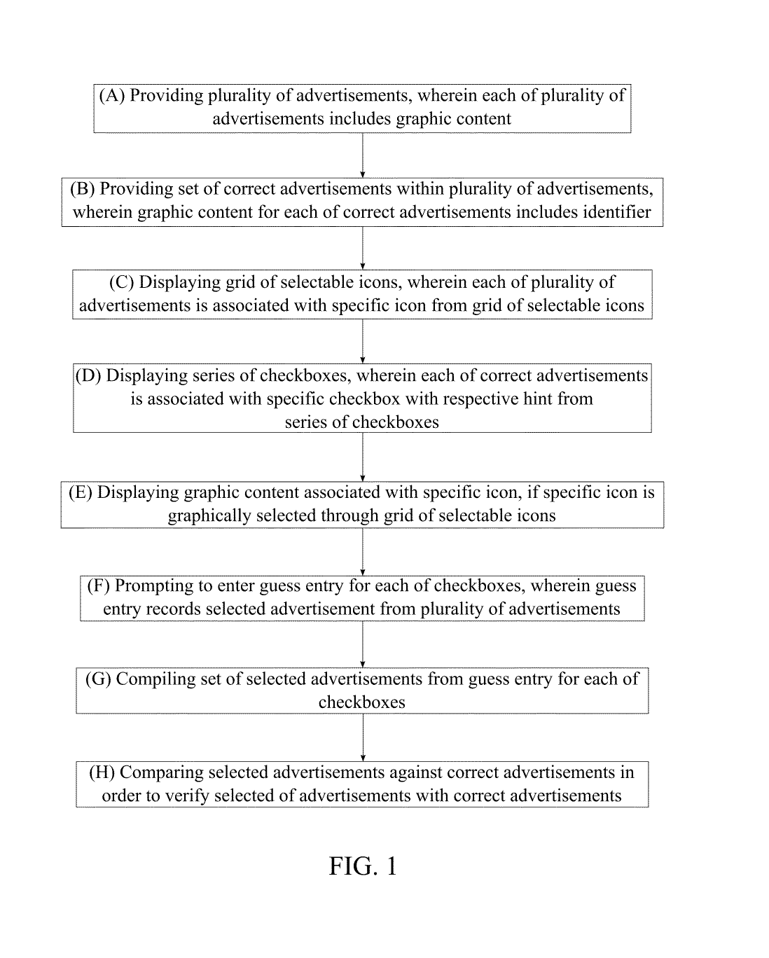

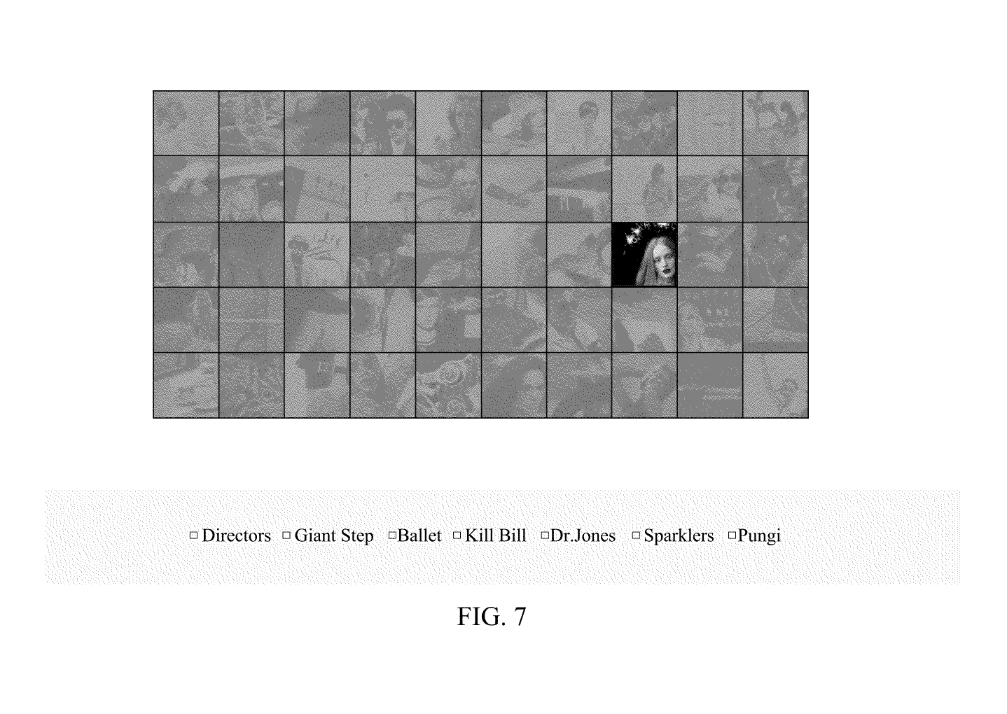

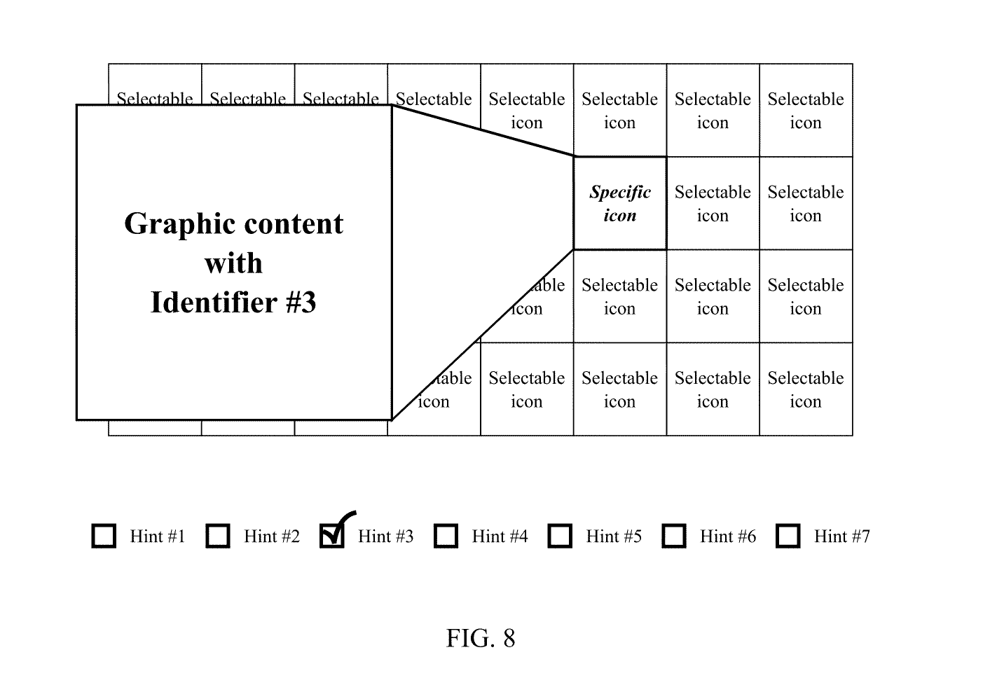

The overall process for the method portion of the present invention is depicted in FIG. 1. The overall process of the present invention begins by displaying the plurality of advertisements to the user in the form of a grid of selectable icons, an example of this is seen in FIG. 7 and FIG. 8; wherein each of the plurality of advertisements is associated with a specific icon from the grid of selectable icons (Step C). The grid is defined by a number of rows and columns. The number of rows and columns may vary depending on the number of advertisements within the plurality of advertisements. The selectable icons may also be color coded to aid the user in differentiating between one selectable icon and the adjacent selectable icon. Furthermore, the design of the icon may vary for increased aesthetic appeal or for various different applications. Next in the overall process, a series of checkboxes is displayed alongside the grid of selectable icons, wherein each of the correct advertisements is associated with a specific checkbox with a respective hint from the series of checkboxes (Step D). Displayed alongside the specific checkbox is the respective hint; conveying to the user what to look for in the graphic content of the advertisements. The respective hint provides the user with additional information about each of the correct advertisements, similar to a hint for a crossword puzzle. The number of checkboxes correlates to the number of correct advertisements and may vary depending on the preferences of an administrating entity in charge of the present invention. The administrating entity is most often the company or entity in charge of the website that is hosting the present invention. The administrator entity usually provides the plurality of advertisements and the associated components required for the various steps of the present invention.

Next in the overall process, the user is allowed to select a specific icon from the grid of selectable icons in order to view the associated graphic content. In particular, selecting the specific icon from the grid of selectable icons will cause the present invention to display the graphic content associated with the specific icon (Step E). The quality, size, and medium for displaying the graphic content may vary depending on the type of user device, Internet connection, and user preferences. The graphic content is preferably displayed to the user in a full screen mode to ensure the user is viewing the graphic content of the advertisement only, all other content on the website is not displayed or is covered by the graphic content. This allows the present invention to accurately monitor the activities of the user, which is described in further detailed below. The user selects each icon from the grid of selectable icons and views the graphic content associated with the specific icon in order to search/hunt for the identifiers, and in turn the set of correct advertisements. In order to win the game, the user must select a large majority of icons in order to correctly identify the correct advertisements. This in turn ensures the user views the majority of advertisements, one of the main goals of the present invention.

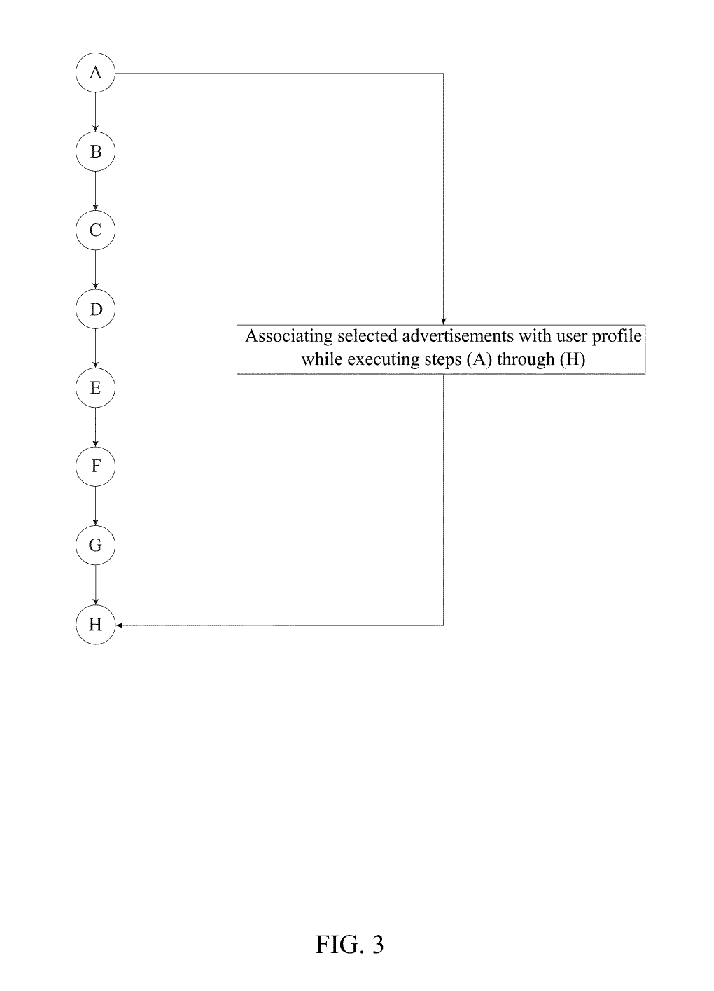

Continuing the overall process, the present invention then prompts the user to enter a guess entry for each of the checkboxes, wherein the guess entry records a selected advertisement from the plurality of advertisements (Step F). Through this process the user submits his or her guesses for each of the correct advertisements. The user may enter the guess entry throughout the game and upon entering a guess entry for each of the checkboxes, these guess entries are compiled into a set of selected advertisements in the form of a score card, thus entering him or her into the running for the prize (Step G). Finally, the present invention verifies the score card by comparing the selected advertisements against the correct advertisements (Step H). The aforementioned overall process is repeated for a multitude of users; wherein the selected advertisements, the score card, for each user is associated with a user profile as seen in FIG. 3. Prior to participating in the present invention, the user is required to create a user profile. The user profile includes descriptive information about the user; descriptive information includes, but is not limited to, first name, last name, age, sex, height, weight, occupation, email address, phone number, and residency address. The user profile is used to differentiate the multitude of users, award the prize appropriately, and track descriptive metrics about each user's behavior during the processes of the present invention.

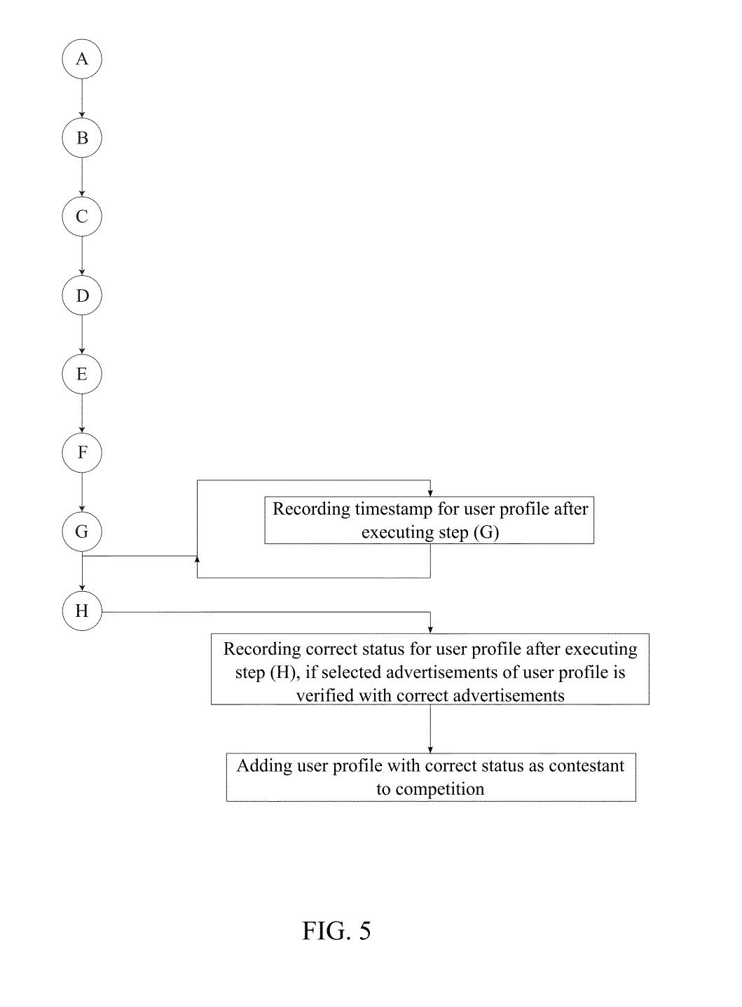

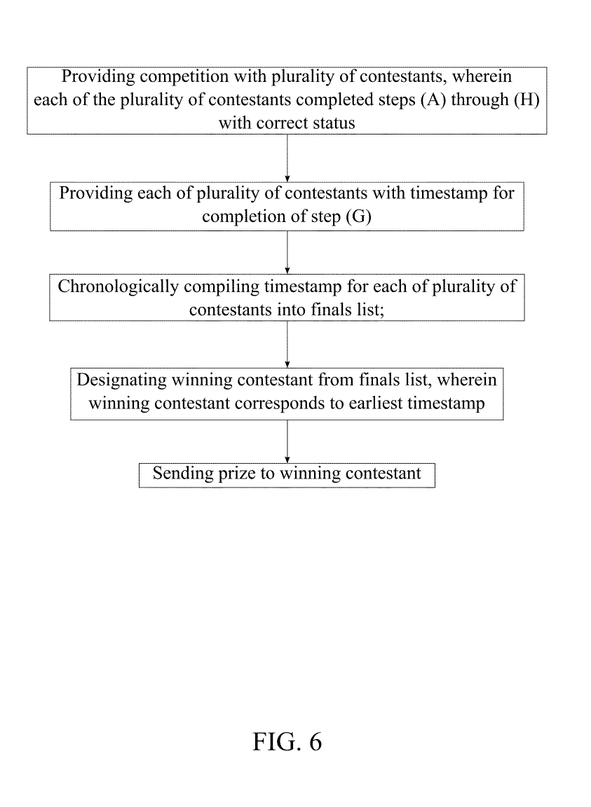

The winner of the game may be determined through a variety of means but the preferred method is based on the earliest submission of a verified score card, i.e. the selected advertisements for a single user, an overview of this process is depicted in FIG. 6. After the execution of (Step H), the present invention marks all of the user profiles whose score card is valid. In particular, if the selected advertisements of a user profile is verified with the correct advertisements, then a correct status for the user is recorded after the execution of (Step H). All user profiles with a correct status are automatically added to a competition as a contestant. The time submission is determined by a timestamp that is recorded at the time of score card submission, in particular after executing (Step G) for each user profile as seen in FIG. 5. A winning contestant from the plurality of contestants is designated by the present invention by first chronologically compiling the timestamps for each of the plurality of contestants into a finals list. Next, the winning contestant is identified based on the earliest timestamp within the finals list. The present invention then sends the winning contestant a prize; information from the associated user profile of the winning contestant is used to deliver the prize. Various types of prizes may be used for the present invention, each sent to the winning contestant by the appropriate delivery system. Some examples of prizes includes, but is not limited to, money, discount coupons, vacation trips, and other similar offers. In some embodiments of the present invention, more than one contestant may win the game, in which case the winning contestants would depend on the first number of earliest timestamps, wherein the number of winning contestants is preset by the administrator entity.

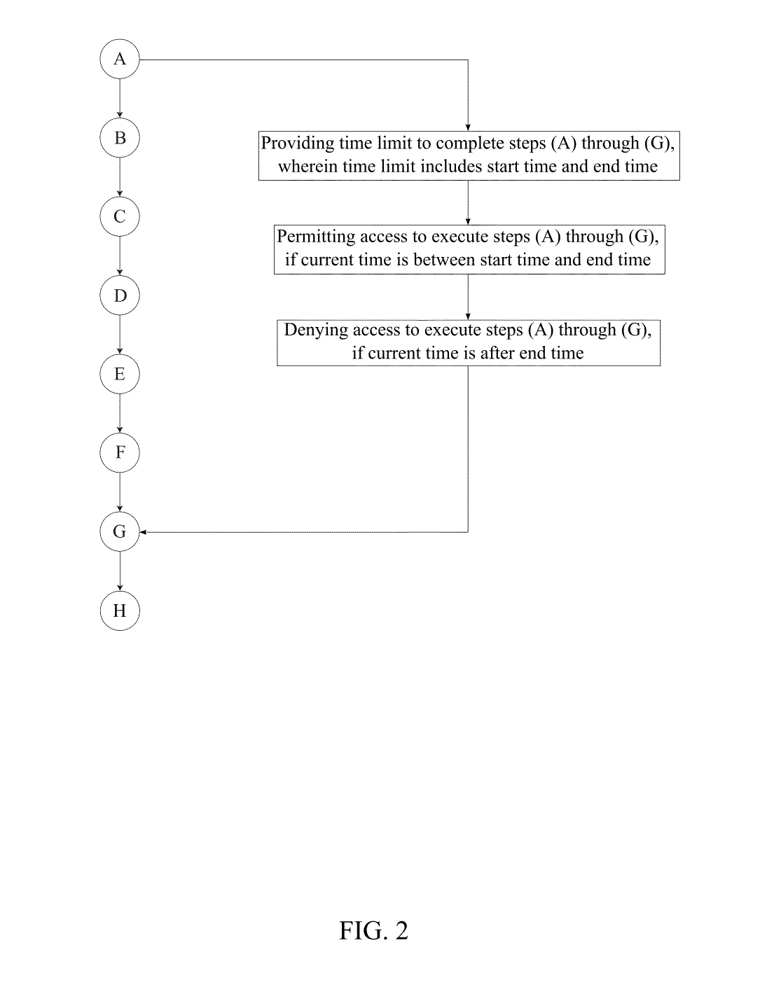

The preferred embodiment of the present invention utilizes a time limit for each instance of the game. The time limit sets a period of time for each instance of the game. When the time limit expires, the various components of the game reset and the game begins again. The time limit indicates how long the user has to complete (Step A) through (Step G) as seen in FIG. 2. More specifically, the time limit includes a start time and an end time. If a current time is between the start time and the end time, then the present invention permits the user to execute (Step A) through (Step G). Alternatively, if the current time is after the end time, the present invention denies the user to execute (Step A) through (Step G). The time limit is set by the administrator entity prior to the beginning of the game. This features provides additional incentive for users to keep playing the game and therefore consuming more advertisements.

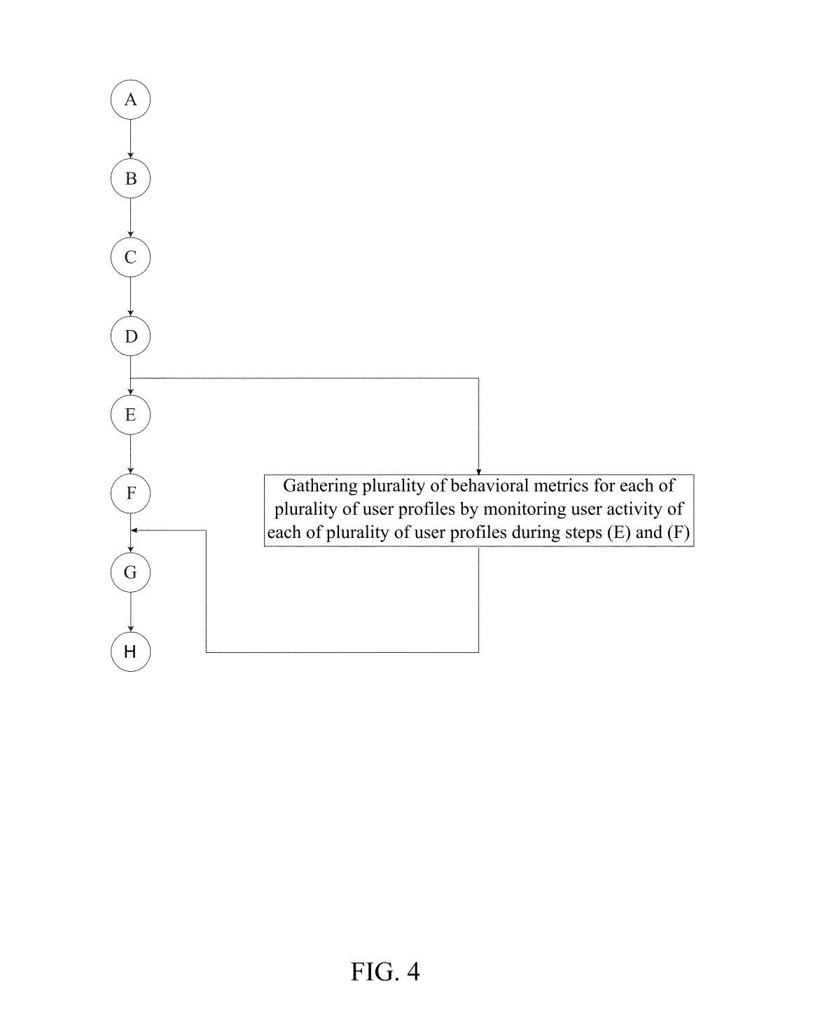

The present invention also monitors the user selections and user input to determine the effectiveness and success of various advertisements from the plurality of advertisements. This is achieved through the gathering of a plurality of behavioral metrics for each of the plurality of user profiles. The present invention monitors user activity of each of the plurality of user profiles during (Step E) and (Step F) as depicted in FIG. 4. One of the main behavioral metrics that the present invention records is a viewing time duration for each of the plurality of advertisements, this may be directly correlated to the effectiveness and quality of the associated graphic content. Another of the main behavioral metrics recorded is a number of views for each of the plurality of advertisements. Because the present invention displays the graphic content of each advertisement in full screen mode, the present invention is able to collect the aforementioned behavioral metrics with a higher degree of accuracy. The collection of the plurality of behavioral metrics is one of the unique and novel aspects of the present invention. The plurality of behavioral metrics may then be used to for further development of advertisements and other similar purposes.

Although the invention has been explained in relation to its preferred embodiment, it is to be understood that many other possible modifications and variations can be made without departing from the spirit and scope of the invention as hereinafter claimed.

What is claimed is:

1. A game and competition based method for online advertisement by executing computer-executable instructions stored on a non-transitory computer-readable medium, the method comprises the steps of:
(A) providing a plurality of advertisements, wherein each of the plurality of advertisements includes graphic content;
(B) providing a set of correct advertisements within the plurality of advertisements, wherein the graphic content for each of the correct advertisements includes an identifier;
(C) displaying a grid of selectable icons, wherein each of the plurality of advertisements is associated with a specific icon from the grid of selectable icons;
(D) displaying a series of checkboxes, wherein each of the correct advertisements is associated with a specific checkbox with a respective hint from the series of checkboxes;
(E) displaying the graphic content associated with the specific icon, if the specific icon is graphically selected through the grid of selectable icons;
(F) prompting to enter a guess entry for each of the checkboxes, wherein the guess entry records a selected advertisement from the plurality of advertisements;
(G) compiling a set of selected advertisements from the guess entry for each of the checkboxes; and
(H) comparing the selected advertisements against the correct advertisements in order to verify the selected of advertisements with the correct advertisements.

2. The game and competition based method for online advertisement by executing computer-executable instructions stored on a non-transitory computer-readable medium, the method as claimed in claim 1 comprises the steps of:
associating the selected advertisements with a user profile while executing steps (A) through (H);
recording a timestamp for the user profile after executing step (G);
recording a correct status for the user profile after executing step (H),
if the selected advertisements of the user profile is verified with the correct advertisements; and
adding the user profile with the correct status as a contestant to a competition.

3. The game and competition based method for online advertisement by executing computer-executable instructions stored on a non-transitory computer-readable medium, the method as claimed in claim 1 comprises the steps of:
providing a competition with a plurality of contestants, wherein each of the plurality of contestants completed steps (A) through (H) with a correct status;
providing each of the plurality of contestants with a timestamp for completion of step (G);
chronologically compiling the timestamp for each of the plurality of contestants into a finals list;
designating a winning contestant from the finals list, wherein the winning contestant corresponds to an earliest timestamp; and
sending a prize to the winning contestant.

4. The game and competition based method for online advertisement by executing computer-executable instructions stored on a non-transitory computer-readable medium, the method as claimed in claim 1 comprises the steps of:
providing a time limit to complete steps (A) through (G), wherein the time limit includes a start time and an end time;
permitting access to execute steps (A) through (G),
if a current time is between the start time and the end time; and
denying access to execute steps (A) through (G),
if the current time is after the end time.

5. The game and competition based method for online advertisement by executing computer-executable instructions stored on a non-transitory computer-readable medium, the method as claimed in claim 1 comprises the steps of:
providing a plurality of user profiles, wherein each of the plurality of user profiles completed steps (A) through (H); and
gathering a plurality of behavioral metrics for each of the plurality of user profiles by monitoring user activity of each of the plurality of user profiles during steps (E) and (F).

6. The game and competition based method for online advertisement by executing computer-executable instructions stored on a non-transitory computer-readable medium, the method as claimed in claim 5, wherein a number of views for each of the plurality of advertisements is recorded as one of the plurality of behavioral metrics.

7. The game and competition based method for online advertisement by executing computer-executable instructions stored on a non-transitory computer-readable medium the method as claimed in claim 5, wherein a viewing time duration for each of the plurality of advertisements is recorded as one of the plurality of behavioral metrics.

8. The game and competition based method for online advertisement by executing computer-executable instructions stored on a non-transitory computer-readable medium the method as claimed in claim 1, wherein the identifier is a graphic-based identifier.
